(19) United States
(12) Patent Application Publication
(10) Pub. No.: US 2006/0089026 A1
(43) Pub. Date: Apr. 27, 2006

(54) Apparatus for connecting electricity sources

(75) Inventor: Sang-Hoon Song, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/254,695

(22) Filed: Oct. 21, 2005

(30) Foreign Application Priority Data
Oct. 23, 2004 (KR) 10-2004-0085130

(51) Int. Cl. H01R 13/44

(52) U.S. Cl. 439/131

(57) ABSTRACT

An apparatus for connecting electricity sources including a first case having an insertion hole, and a second case coupled to the first case to form a receiving space between the first and second cases. Further, the second case has a protruding boss portion corresponding to the insertion hole. Also included is a fixing member installed in the insertion hole and having slots at both sides thereof, a connection plate installed at the boss portion and configured to be connected to a printed circuit board, and a plug terminal assembly installed at the fixing member and having one end portion contacting the connection plate and the other end portion penetrating the insertion hole of the first case and being exposed to an outside of the first case. In addition, the plug terminal assembly includes at least two plug terminals configured to be unfolded from the slots of the fixing member into an unfolded state and insertable into an outlet, and a maintaining mechanism configured to maintain the at least two terminals in the unfolded state.

### CROSS REFERENCE TO A RELATED APPLICATION

The present application claims priority to Korean Patent Application number 10-2004-0085130 filed in Korea on Oct. 23, 2004, the entire contents of which is hereby incorporated by reference in its entirety.

### BACKGROUND OF THE INVENTION

1. Field of the Invention

The present invention relates to an apparatus for connecting electricity sources, and more particularly, to an apparatus for connecting electricity sources that firmly maintains an unfolded state of a plug terminal included in the apparatus.

2. Description of the Background Art

In general, an apparatus for connecting electricity sources includes, for example, an adapter for converting a high voltage into a low voltage or a charger for charging a mobile communication terminal. For example, the charger connects the mobile terminal to an outlet of a power supply unit (hereinafter, referred to as an outlet) to thereby recharge the mobile terminal.

Further, the apparatus for connecting electricity sources may be categorized into a fixed type and a folding type according to whether or not a corresponding plug terminal of the apparatus can be folded. For example, FIG. 1 illustrates a related art folding type apparatus.

As shown in FIG. 1, the related art apparatus 10 for connecting electricity sources includes a first case 11 having an insertion hole 11a, and a second case 12 coupled to the first case 11a to form a receiving space 12a between the first and second cases 11, 12. The second case 12 includes a protruding boss portion 12b to correspond to the insertion hole 11a. Further, the apparatus 10 also includes a fixing member 13 installed within the insertion hole 11a of the first case 11, a connection plate 14 installed at the boss portion 12b of the second case 12 so as to be connected to a printed circuit board (not shown), and a plug terminal assembly 15 rotatably installed at the fixing member 13.

In addition, the plug terminal assembly 15 includes two plug terminals 15a (only one terminal is shown) selectively received in a terminal receiving groove 11b of the first case 11, and a shaft 15c inserted in the fixing member 13 and connecting the two plug terminals 15a.

The operation of the related art apparatus for connecting electricity sources will now be described.

When the apparatus 10 is not used, the plug terminals 15a are inserted (folded) in the terminal receiving groove 11b of the first case 11. Further, when the apparatus 10 is used, the user unfolds the plug terminals 15a so the plug terminals 15a may be inserted into an outlet. As shown, in the unfolded state, a connection protrusions 15d of the plug terminals 15a contact the connection plate 14, thereby allowing an electric current to flow through the plug terminal assembly 15 and the connection plate 14 when the terminals 15 are inserted into the outlet (i.e., the electrically-connected state). That is, when a user inserts the plug terminals 15a into the outlet, electric current flows from the outlet through the plug assembly 15 and connection plate 14 to a mobile terminal connected to the apparatus 10.

However, the unfolded state of the plug terminal assembly is not firmly maintained. Therefore, the unfolded plug terminal assembly is flimsy, thereby inconveniencing the user. Further, because the plug assembly is not firmly maintained, the reliability of the apparatus is degraded.

### BRIEF DESCRIPTION OF THE INVENTION

Accordingly, one object of the present invention is to at least address the above and other noted problems.

Another object of the present invention is to provide a novel apparatus for connecting electricity sources, which improves the reliability of a product by firmly maintaining an unfolded state of a plug terminal assembly included in the apparatus.

To achieve these and other advantages and in accordance with the purpose of the present invention, as embodied and broadly described herein, the present invention provides a novel apparatus for connecting electricity sources including a first case having an insertion hole, and a second case coupled to the first case to form a receiving space between the first and second cases. Further, the second case has a protruding boss portion corresponding to the insertion hole. Also included is a fixing member installed in the insertion hole and having slots at both sides thereof, a connection plate installed at the boss portion and configured to be connected to a printed circuit board, and a plug terminal assembly installed at the fixing member and having one end portion contacting the connection plate and the other end portion penetrating the insertion hole of the first case and being exposed to an outside of the first case. In addition, the plug terminal assembly includes at least two plug terminals configured to be unfolded via the slots of the fixing member into an unfolded state and inserted into an outlet, and a maintaining mechanism configured to maintain the at least two terminals in the unfolded state.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1 is a longitudinal sectional view illustrating a related art apparatus for connecting electricity sources;

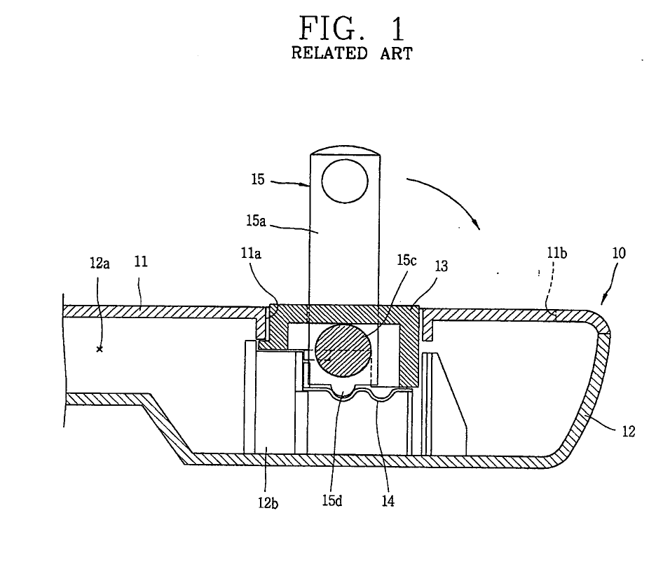

FIG. 2 is a perspective view illustrating an apparatus for connecting electricity sources according to the present invention;

FIG. 3 is an exploded perspective view illustrating an apparatus for connecting electricity source according to the present invention;

FIG. 4 is a cross-sectional view of the apparatus illustrated in FIG. 2;

FIG. 5 is a perspective view illustrating a coupling state between a fixing member and a plug terminal assembly of an apparatus for connecting electricity sources according to the present invention; and

FIGS. 6 and 7 are perspective views illustrating a support protrusion of the plug terminal assembly of the apparatus for connecting electricity sources according to the present invention.

### DETAILED DESCRIPTION OF THE PREFERRED EMBODIMENTS

Reference will now be made in detail to the preferred embodiments of the present invention, examples of which are illustrated in the accompanying drawings.

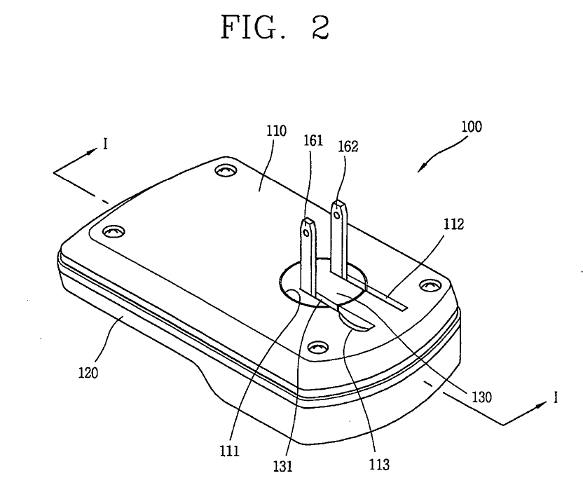

As shown in FIGS. 2-4, the apparatus 100 for connecting electricity sources according to the present invention includes a first case 110 having an insertion hole 111, and a second case 120 coupled to the first case 110 to form a receiving space 121 therein. Further, the second case 120 has a protruding boss portion 122 to correspond to the insertion hole 111. The apparatus 100 also includes a fixing member 130 installed in the insertion hole 111 and having slots 131 at both sides.

Also shown are a connection plate 140 installed at the boss portion 122 so as to be connected to a printed circuit board 150, and a plug terminal assembly 160 rotatably installed at the fixing member 130 and having one end portion contacting the connection plate 140 and the other end portion penetrating the insertion hole 111 and being exposed to an outside of the first case 110. FIGS. 2-4 illustrate an example in which the insertion hole 111 is at an upper middle portion of the first case 110. However, the location of the insertion hole 111 and corresponding plug assembly 160 may be located at different portions of the apparatus.

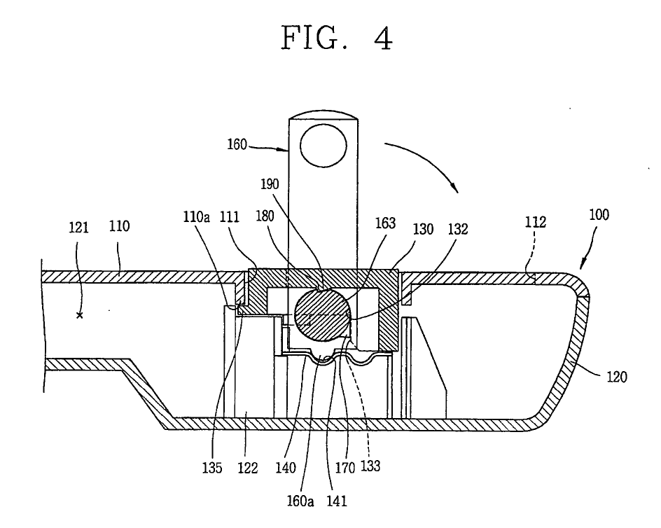

Further, the plug terminal assembly 160 includes a first plug terminal 161, a second plug terminal 162, and a shaft 163 connecting the first plug terminal 161 with the second plug terminal 162. As shown in FIG. 4, the shaft 163 is rotatably inserted in a shaft groove 132 of the fixing member 130. In addition, the shaft 163 is preferably made with an insulating material.

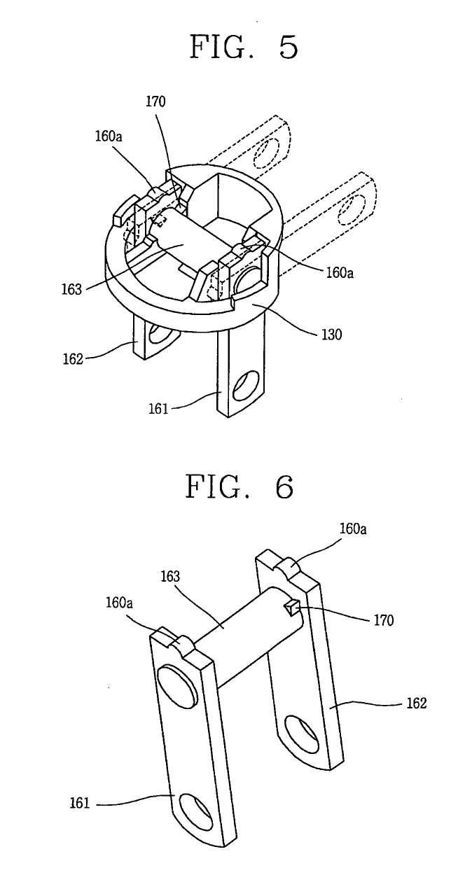

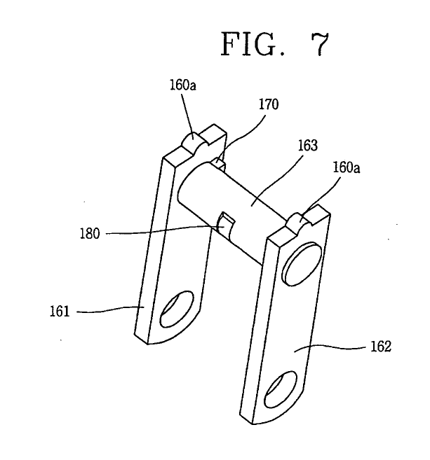

Further, FIG. 4 illustrates a support protrusion 170 formed on the shaft 163 and that is configured to contact a support surface 133 of the fixing member 130 so as to firmly maintain an unfolded state of the plug terminal assembly 160. In more detail, as shown in FIG. 4, the support surface 133 is formed at one side of the fixing member 130, and the support protrusion 170 is formed at one side of the shaft 163, corresponding to the support surface 133. Thus, the support protrusion 170 contacts the support surface 133 when the plug assembly 160 is unfolded to thereby firmly maintain the unfolded state of the plug assembly 160. FIGS. 5-7 illustrate examples of the support protrusion 170 in greater detail.

In addition, as shown in FIGS. 4 and 8, a groove 180 is preferably formed at another side of the shaft 163, and a protrusion 190 is formed at a corresponding position at the fixing member 130. Accordingly, when the plug assembly 160 is in the unfolded state, the support protrusion 170 is supported by the support surface 133, and simultaneously the protrusion 190 is inserted in the groove 180, so the unfolded state of the plug terminal assembly 160 is firmly maintained.

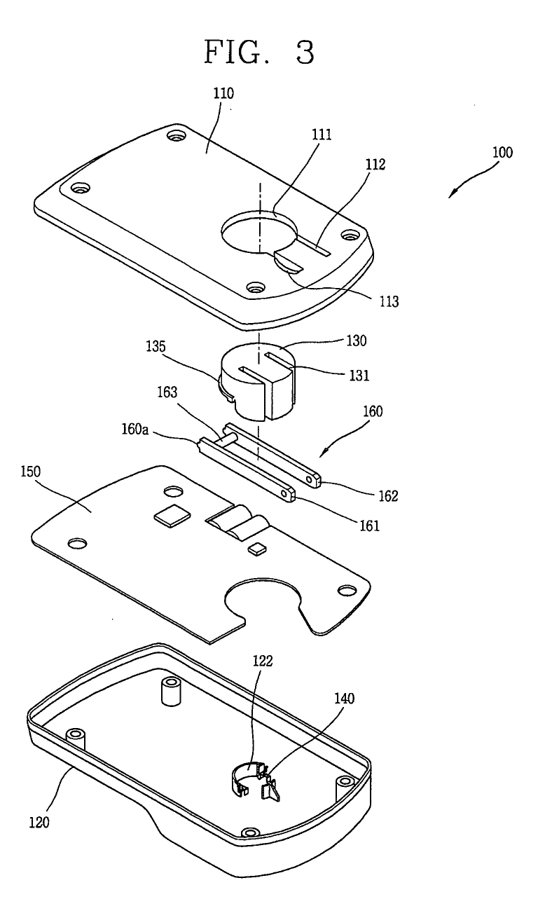

Also, as shown in FIGS. 3-7, a connection protrusion 160a is preferably formed on an end of each of the first and second plug terminals 161 and 162. As shown in FIG. 4, a connection groove 241 is formed at the connection plate 240 and corresponds to the connection protrusions 160a. Thus, in the unfolded state, the connection protrusions 160a of the first and second plug terminals 161 and 162 contact the connection groove 241.

Further, as shown in FIGS. 2 and 4, when the plug terminals 161 and 162 are unfolded, end portions of the first and second plug terminals 161 and 162 penetrate the insertion hole 111 and are exposed to an outside of the first case 110. In addition, with reference to FIGS. 3 and 4, the end portions of the first and second plug terminals 161 and 162 are inserted in a terminal-receiving groove 112 of the first case 110 when the plug assembly is in the folded state.

In addition, as shown in FIG. 3, a flange 135 is formed at an outer circumference of the fixing member 130 so the fixing member 130 can be smoothly inserted in the insertion hole 111 of the first case 110. That is, the flange 135 is stopped by an end portion 110a thus to be assembled to the apparatus.

An operation of the apparatus according to the present invention will now be described with reference to FIGS. 2 to 5.

To unfold the plug terminal assembly 150, the user places his/her finger into a finger insertion hole 113 (see FIG. 2) and pulls back the first plug terminal 161. Thus, the first and second plug terminals 161, 162 are rotated about the shaft 163. Here, as specifically shown in FIG. 4, the connection protrusions 160a contact the connection groove 241 such that an electrical connection state is achieved when the plug terminals 161 and 162 are inserted into the outlet.

Further, when the rotation of the first and second plug terminals 161, 162 is completed, the protrusion 190 is inserted in the groove 180. Simultaneously, the support protrusion 170 contacts the support surface 133 of the fixing member 130, such that the plug terminal assembly 160 is firmly maintained in the unfolded state.

As described so far, the plug terminal assembly is firmly maintained in the unfolded state. Thus, a user can conveniently insert the plug terminal assembly into an outlet, and the reliability of the apparatus is improved.

Further, the illustrated plug terminal assembly includes two plug terminals. However, any number of plug terminals may be included in the plug terminal assembly.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An apparatus for connecting electricity sources, comprising:
a first case having an insertion hole;
a second case coupled to the first case to form a receiving space between the first and second cases, the second case having a protruding boss portion corresponding to the insertion hole;
a fixing member installed in the insertion hole and having slots at both sides thereof;
a connection plate installed at the boss portion and configured to be connected to a printed circuit board; and
a plug terminal assembly installed at the fixing member and having one end portion contacting the connection plate and the other end portion penetrating the insertion hole of the first case and being exposed to an outside of the first case,
wherein the plug terminal assembly includes at least two plug terminals configured to be unfolded from the slots of the fixing member into an unfolded state and insertable into an outlet, and includes a maintaining mechanism configured to maintain the at least two terminals in the unfolded state.

2. The apparatus of claim 1, wherein the plug terminal assembly further comprises:
an insulated shaft connecting the at least two plug terminals and being rotatably inserted in a shaft groove of the fixing member.

3. The apparatus of claim 2, wherein the maintaining mechanism includes a support protrusion formed on the insulated shaft and configured to contact a support face of the fixing member when the at least two plug terminals are unfolded so as to maintain the unfolded state of the at least two plug terminals.

4. The apparatus of claim 3, wherein the maintaining mechanism further includes a groove formed in the insulated shaft, and a protrusion formed on the fixing member at a location corresponding to the groove such that when the at least two plug terminals are unfolded, the protrusion rests within the groove so as to maintain the unfolded state of the at least two plug terminals.

5. The apparatus of claim 1, wherein respective first ends of the at least two plug terminals include a connection protrusion configured to connect with a connection groove formed on the connection plate at a location corresponding to the connection protrusions such that when the at least two plug terminals are unfolded, the connection protrusions contact the connection groove to establish an electrical connection when the at least two terminals are inserted into the outlet.

6. The apparatus of claim 5, wherein, when the at least two terminals are unfolded, respective second ends of the at least two plug terminals penetrate the insertion hole of the first case and are exposed to the outside of the first case, and when the at least two plug terminals are in a folded state, the respective second ends of the at least two plug terminals are inserted in corresponding terminal receiving grooves included in the first case.

7. The apparatus of claim 6, wherein at least one of the terminal receiving grooves includes a finger insertion portion such that a user can insert his or her finger into the finger insertion portion to unfold the at least two plug terminals.

8. The apparatus of claim 1, wherein the apparatus comprises a battery recharger or a voltage converter for a mobile terminal.

9. The apparatus of claim 4, wherein the groove is formed in the middle of the insulated shaft, and the support protrusion is formed at an end of the insulated shaft at a position where the insulated shaft is connected with a respective plug terminal.

10. The apparatus of claim 1, wherein a flange is formed at an outer circumference of the fixing member, and the flange is stopped by an end portion.

11. An electrical connection apparatus, comprising:
a plug terminal assembly installed within a case and including at least two plug terminals configured to be unfolded into an unfolded state and insertable into an outlet; and
a maintaining mechanism configured to maintain the at least two terminals in the unfolded state.

12. The apparatus of claim 11, further comprising:
a fixing member installed in an insertion hole of the case and having slots at both sides thereof to allow the at least two plug terminals to pass through the slots and be in the unfolded state,
wherein the plug terminal assembly further comprises:
an insulated shaft connecting the at least two plug terminals and being rotatably inserted in a shaft groove of the fixing member.

13. The apparatus of claim 12, wherein the maintaining mechanism includes a support protrusion formed on the insulated shaft and configured to contact a support face of the fixing member when the at least two plug terminals are unfolded so as to maintain the unfolded state of the at least two plug terminals.

14. The apparatus of claim 13, wherein the maintaining mechanism further includes a groove formed in the insulated shaft, and a protrusion formed on the fixing member at a location corresponding to the groove such that when the at least two plug terminals are unfolded, the protrusion rests within the groove so as to maintain the unfolded state of the at least two plug terminals.

15. The apparatus of claim 11, further comprising:
a connection plate formed within the case and configured to be connected with a printed circuit board,
wherein respective first ends of the at least two terminals includes a connection protrusion configured to connect with a connection groove formed in the connection plate at a location corresponding to the connection protrusions such that when the at least two terminals are unfolded, the connection protrusions contact the connection groove to establish an electrical connection when the at least two terminals are inserted into the outlet.

16. The apparatus of claim 15, wherein, when the at least two terminals are unfolded, respective second ends of the at least two plug terminals penetrate the insertion hole of the case and are exposed to the outside of the case, and when the at least two plug terminals are in a folded state, the respective second ends of the at least two plug terminals are inserted in corresponding terminal receiving grooves included in the case.

17. The apparatus of claim 16, wherein at least one of the terminal receiving grooves includes a finger insertion portion such that a user can insert his or her finger into the finger insertion position to unfold the at least two plug terminals.

18. The apparatus of claim 11, wherein the apparatus comprises a battery recharger or a voltage converter for a mobile terminal.

19. The apparatus of claim 14, wherein the groove is formed in the middle of the insulated shaft, and the support protrusion is formed at an end of the insulated shaft at a position where the insulated shaft is connected with a respective plug terminal.

20. The apparatus of claim 12, wherein a flange is formed at an outer circumference of the fixing member, and the flange is stopped by an end portion.
